(19) United States
(12) Patent Application Publication
(10) Pub. No.: US 2026/0084233 A1
(43) Pub. Date: Mar. 26, 2026

(54) FRICTION STIR WELDING METHOD AND FRICTION STIR WELDING APPARATUS

(71) Applicant: SUBARU CORPORATION, Tokyo (JP)

(72) Inventors: Riki TSUTSUMINO, Tokyo (JP); Takashi MURAKAMI, Tokyo (JP)

(21) Appl. No.: 19/276,208

(22) Filed: Jul. 22, 2025

(30) Foreign Application Priority Data
Sep. 24, 2024 (JP) 2024-164781

(51) Int. Cl. B23K 20/12

(52) U.S. Cl. CPC B23K 20/123; B23K 20/1225

(57) ABSTRACT

In a friction stir welding method, a tool is inserted into a joint to be made between a first member and a second member while the tool is rotated, and the first member and the second member, and the tool are relatively moved along the joint such that the first member and the second member are softened, to perform friction stir welding of the first member and the second member. The method includes acquiring a proper rotation speed of the tool for at least two relative movement speeds, acquiring a proper condition of the proper rotation speed for the at least two relative movement speeds, based on the proper rotation speed for the at least two relative movement speeds, and performing the friction stir welding in a condition that satisfies the proper condition in a speed range in which the at least two relative movement speeds exceed 3 m/min.

### CROSS-REFERENCE TO RELATED APPLICATIONS

The present application Claims priority from Japanese Patent Application No. 2024-164781 filed on September 24, 2024, the entire contents of which are hereby incorporated by reference.

### BACKGROUND

The disclosure relates to a friction stir welding method and a friction stir welding apparatus.

Friction stir welding (FSW) that is known as a method of joining members to be joined is to insert a columnar tool into a location at which the members are to be joined to each other while the tool is rotated, to move the members and the tool relatively along the location such that the members to be joined are softened, and to stir the softened members such that the members are joined to each other. The friction stir welding enables joining without melting the members, is unlikely to cause a defect such as a deformation or a cavity, and increases joining strength. For this reason, application of the friction stir welding to various fields, for example, when one or both of the members to be joined are composed of an aluminum die casting material is expected.

As for the friction stir welding, when the heat input amount of frictional heat that is generated due to the rotation of the tool into the members to be joined is out of a proper range, there is a possibility that the joining strength of the members decreases. For example, when the heat input amount is too large, an excess burr can be generated on the surfaces of the joined members. When the heat input amount is too small, insufficient stirring can cause defects on the surfaces of the members or therein. As for techniques disclosed in, for example Japanese Unexamined Patent Application Publication (JP-A) No. 2023-147697, JP-A No. 2000-301361, and JP-A No. 2010-253534, conditions such as a relative movement speed and the rotation speed of the tool are set such that the joined members have no defects, and the friction stir welding is performed.

### SUMMARY

An aspect of the disclosure provides a friction stir welding method in which a tool is inserted into a joint to be made between a first member and a second member while the tool is rotated, and the first member and the second member, and the tool are relatively moved along the joint to be made such that the first member and the second member are softened, to perform friction stir welding of the first member and the second member. The friction stir welding method includes acquiring a proper rotation speed of the tool for each of at least two relative movement speeds, acquiring a proper condition of the proper rotation speed for each of the at least two relative movement speeds, based on the proper rotation speed for each of the at least two relative movement speeds, and performing the friction stir welding of the first member and the second member in a speed range in which a relative movement speed of the first member and a relative movement speed of the second member exceed 3 m/min in a condition that satisfies the proper condition.

An aspect of the disclosure provides a friction stir welding apparatus configured to insert a tool into a joint to be made between a first member and a second member while the tool is rotated, and relatively move the first member and the second member, and the tool along the joint to be made such that the first member and the second member are softened, to perform friction stir welding of the first member and the second member. The friction stir welding apparatus includes a storage and a controller. The storage is configured to store a proper condition of a proper rotation speed for each of at least two relative movement speeds, the proper condition being acquired based on the proper rotation speed for each of the at least two relative movement speeds. The controller is configured to set a rotation speed and a relative movement speed of the tool in a speed range in which a relative movement speed of the first member and a relative movement speed of the second member exceed 3 m/min in a condition that satisfies the proper condition in a speed range and control actuation of the friction stir welding apparatus.

An aspect of the disclosure provides a friction stir welding apparatus configured to insert a tool into a joint to be made between a first member and a second member while the tool is rotated, and relatively move the first member and the second member, and the tool along the joint to be made such that the first member and the second member are softened, to perform friction stir welding of the first member and the second member. The friction stir welding apparatus includes circuitry. The circuitry is configured to store a proper condition of a proper rotation speed for each of at least two relative movement speeds, the proper condition being acquired based on the proper rotation speed for each of the at least two relative movement speeds. The circuitry is configured to set a rotation speed and a relative movement speed of the tool in a speed range in which a relative movement speed of the first member and a relative movement speed of the second member exceed 3 m/min in a condition that satisfies the proper condition. The circuitry is configured to control actuation of the friction stir welding apparatus.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating an example of the structure of a friction stir welding apparatus according to an embodiment of the disclosure;

FIG. 2 illustrates the operation of the friction stir welding apparatus according to an embodiment of the disclosure;

FIG. 3 illustrates the operation of the friction stir welding apparatus according to an embodiment of the disclosure;

FIG. 4 illustrates a variation in the temperature of a tool during joining;

FIG. 5 is a flowchart illustrating a procedure for acquiring a proper condition in a friction stir welding method according to an embodiment of the disclosure;

FIG. 6 illustrates an example of the proper range of a proper rotation speed for a relative movement speed according to an embodiment of the disclosure;

FIG. 7 illustrates an example of the proper range of the proper rotation speed for the relative movement speed according to an embodiment of the disclosure; and

FIG. 8 is a flowchart illustrating an example of a joining process in the friction stir welding method according to an embodiment of the disclosure.

### DETAILED DESCRIPTION

Friction stir welding enables stable joining strength to be acquired unlike mechanical joining such as self-pierce riveting (SPR) or flow drilling screw (FDS) and another joining method in which members are not melted such as chemical joining with an adhesive, but a joining speed is lower than that in another joining method such as welding. Accordingly, the friction stir welding uses a heat input amount that is properly set and an increased joining speed in order to improve productivity.

As for the technique disclosed in JP-A No. 2023-147697, test joining for members to be joined is performed a predetermined number of times in advance by using a friction stir welding apparatus, the lower limit and upper limit of the range of joining temperature at which the desired quality of the friction stir welding can be ensured in joining conditions (a rotation speed and a movement speed) for every divided section are set, the movement speed and the rotation speed of a joining tool at this time are acquired a predetermined number of times to set a reference movement speed and a reference rotation speed, the current joining temperature is acquired for every divided section when the friction stir welding is actually performed, the reference joining temperature closest to the acquired current joining temperature is selected, the reference movement speed corresponding to the selected reference joining temperature is selected as the target value of the movement speed, and the reference rotation speed corresponding to the selected reference joining temperature is selected as the target value of the rotation speed. For this reason, when members are joined to each other, the test joining is performed a predetermined number of times every time. When the friction stir welding is actually performed, the current joining temperature is measured. Accordingly, it is difficult to improve the productivity.

As for the technique disclosed in JP-A No. 2000-301361, processing conditions such as the specification of a friction stir welding tool, the rotation speed of the tool, the joining speed of the tool, and the depth of insertion of the tool are adjusted, and the heat input amount is controlled so as to be substantially constant. As for the technique disclosed in JP-A No. 2000-301361, however, the heat input amount into a workpiece is controlled through direct feedback of the measurement value of the temperature of the joint of the workpiece or the vicinity thereof during joining, an increase in the joining speed (the relative movement speeds of the tool and the workpiece) is limited, and it is difficult to improve the productivity.

As for the technique disclosed in JP-A No. 2010-253534, a joint is formed between joining materials that are relatively moved at a predetermined rotation speed and a movement speed, whether a defect that opens from the surfaces of the joining materials or the surface of the joint and an inner space that is closed by the joining materials and the joint are present in a section intersecting with the formed joint in a longitudinal direction is checked, and when it is determined that neither a defect nor an inner space is present, the rotation speed is decreased, or the movement speed is increased. For this reason, joining, checking, and changing conditions are repeated whenever members are joined to each other until it is determined that neither a defect nor an inner space is present, and it is difficult to improve the productivity.

It is desirable to provide a friction stir welding method and a friction stir welding apparatus that enable the heat input amount to be properly set and enable the productivity to be improved by increasing the joining speed.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Structure of Friction Stir Welding Apparatus

An example of the structure of a friction stir welding apparatus that can be used in a friction stir welding method according to the disclosure will be first described. However, the structure of the friction stir welding apparatus except for a control device is not limited provided that a first member and a second member to be joined and a tool that is inserted into a joint to be made between the first member and the second member can be relatively moved. An example of the structure of the friction stir welding apparatus will now be simply described.

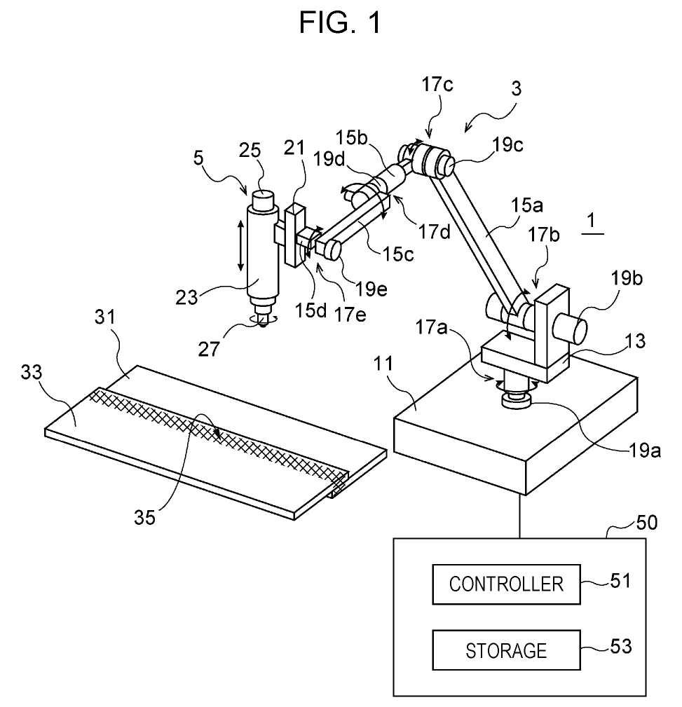

FIG. 1 illustrates an example of the structure of the friction stir welding apparatus.

A friction stir welding apparatus 1 illustrated in FIG. 1 is configured to change the position of a tool 27 along a joint 35 to be made with a portion of a first member 31 and a portion of a second member 33 to be joined overlapping and placed. The friction stir welding apparatus may be configured to change the positions of the first member and the second member with the position of the tool fixed or may be configured to change the positions of the tool and, the first member and the second member together.

The friction stir welding apparatus 1 includes a movable member 3 that is installed on a base 11, a head 5 that is supported at an end of the movable member 3 and that holds the tool 27, and a control device 50 that controls the drive of the friction stir welding apparatus 1. The movable member 3 includes a support member 13, a first arm 15a, a second arm 15b, a third arm 15c, and a fourth arm 15d. The support member 13, the first arm 15a, the second arm 15b, the third arm 15c, and the fourth arm 15d are coupled so as to be rotatable relative to each other.

A coupler 17a for the base 11 and the support member 13 includes a first motor 19a, and the base 11 and the support member 13 relatively rotate about the motor shaft of the first motor 19a. A coupler 17b for the support member 13 and the first arm 15a includes a second motor 19b, and the support member 13 and the first arm 15a relatively rotate about the motor shaft of the second motor 19b. A coupler 17c for the first arm 15a and the second arm 15b includes a third motor 19c, and the first arm 15a and the second arm 15b relatively rotate about the motor shaft of the third motor 19c.

A coupler 17d for the second arm 15b and the third arm 15c includes a fourth motor 19d, and the second arm 15b and the third arm 15c relatively rotate about the motor shaft of the fourth motor 19d. A coupler 17e for the third arm 15c and the fourth arm 15d includes a fifth motor 19e, and the third arm 15c and the fourth arm 15d relatively rotate about the motor shaft of the fifth motor 19e.

The fourth arm 15d includes a head support member 21 that supports the head 5. The head support member 21 includes an up-down movement driver that changes the position of the head 5 in an up-down direction and that is not illustrated. For example, the up-down movement driver includes a ball screw, a linear guide, and a motor, and the rotation of the motor causes the head 5 to move in the up-down direction.

The head 5 includes a holder 23, a tool drive motor 25, and the tool 27. The tool drive motor 25 and the tool 27 are coupled by a rotation shaft, not illustrated, and are held by the holder 23. The tool 27 is rotatably held by the holder 23 and rotates about an axis by the drive of the tool drive motor 25.

The control device 50 functions as a device that controls the drive of the friction stir welding apparatus 1 in a manner in which at least one processor such as a central processing unit (CPU) runs a computer program. The computer program causes the at least one processor to perform an operation described later to be performed by the control device 50. The computer program that is run by the at least one processor may be recorded in a recording medium that functions as a storage 53 described later or may be recorded in another recording medium that is contained in the control device 50 or any recording medium that is externally attachable to the control device 50.

The recording medium that records the computer program may be a magnetic medium such as a hard disk, a floppy disk, or a magnetic tape, an optical recording medium such as a CD-ROM, a DVD, or a Blu-ray (registered trademark), a magneto-optical medium such as a floptical disk, a storage element such as a RAM or a ROM, a flash memory such as a USB memory or a SSD, or another medium that can store the program.

The control device 50 includes a controller 51 and the storage 53. The storage 53 is a storage element such as a RAM or ROM and stores the proper condition of the proper rotation speed of the tool 27 for the relative movement speeds of the first member 31 and the second member 33, and the tool 27. The controller 51 sets the rotation speed or the relative movement speed of the tool 27 in a condition that satisfies the proper condition in a speed range in which the relative movement speeds exceed 3 m/min and controls the actuation of the friction stir welding apparatus 1. A method of acquiring the proper condition that is stored in the storage 53 and the friction stir welding processing of the controller 51 in the proper condition will be described in detail later.

### 2. Operation of Friction Stir Welding Apparatus

The operation of the friction stir welding apparatus will now be described.

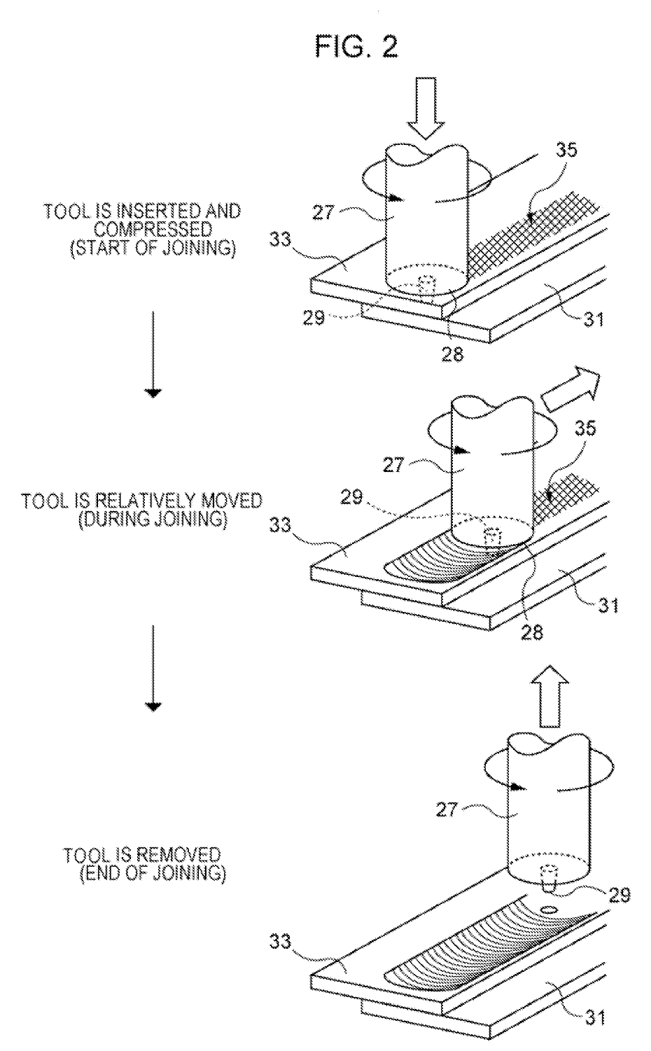

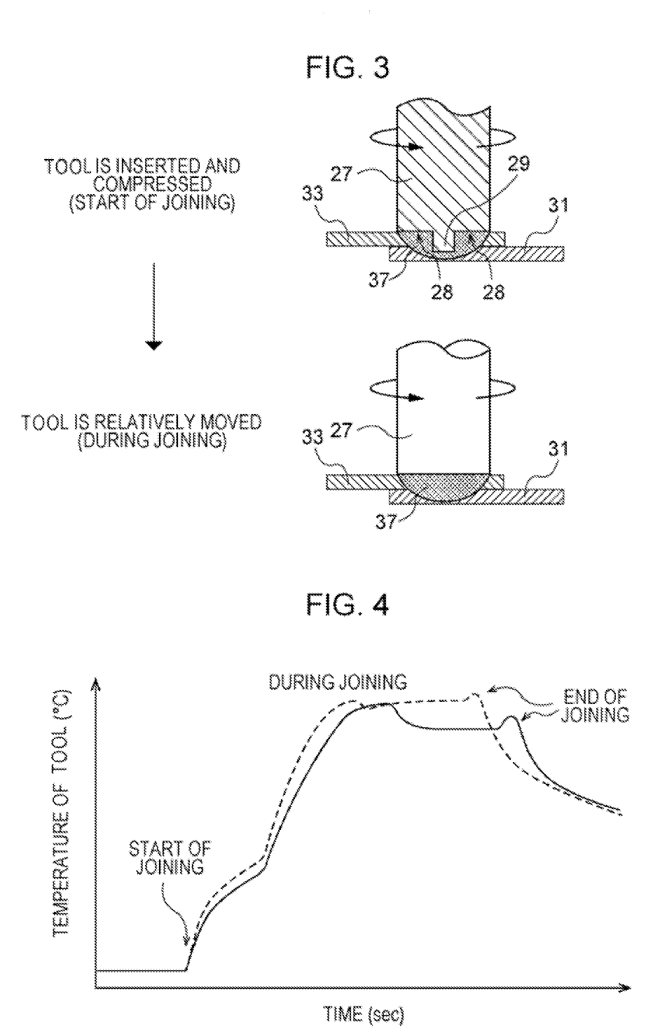

FIG. 2 and FIG. 3 schematically illustrate the operation of the friction stir welding apparatus 1.

The tool 27 includes a shoulder member 28 and a joining pin 29 as illustrated. The joining pin 29 is a small-diameter portion that projects downward from the center of the lower end surface of the tool 27, and an end surface around the joining pin 29 forms the shoulder member 28.

The control device 50 causes the head 5 to descend while causing the tool 27 to be rotated, causes the joining pin 29 of the tool 27 to be inserted into the joint 35 to be made between the first member 31 and the second member 33 to be joined at any start position, and causes the shoulder member 28 to be compressed and pressed against the vicinity of the joint 35 to be made (the start of joining). Consequently, the temperatures of the first member 31 and the second member 33 near the joint 35 to be made are increased due to frictional heat, and the first member 31 and the second member 33 near the joint 35 to be made are softened.

Subsequently, the control device 50 causes the first member 31 and the second member 33, and the tool 27 to relatively move along the joint 35 to be made with the tool 27 rotating and pressed against the joint 35 to be made (during joining). Consequently, the first member 31 and the second member 33 near the joint 35 to be made are stirred (plastic flow), and the first member 31 and the second member 33 are joined to each other.

When the tool 27 reaches any end position on the joint 35 to be made, the control device 50 causes the head 5 to ascend, causes the tool 27 to be removed from the first member 31 and the second member 33, and causes the tool 27 to stop rotating (the end of joining). In this way, the first member 31 and the second member 33 are joined to each other without being melted.

In FIG. 1 and FIG. 2, the joint 35 to be made corresponds to a location at which a side portion of the first member 31 and a side portion of the second member 33 overlap, but the joint 35 to be made may correspond to a location at which the first member 31 and the second member 33 butt against each other.

FIG. 4 illustrates a difference in heat input amount between when joining is proper and when joining is not proper. In FIG. 4, a solid line represents the transition of the temperature of the end of the tool 27 when joining is proper, and a dashed line represents the transition of the temperature of the end of the tool 27 when joining is not proper. In an example represented by the dashed line, the rotation speed is higher than that in an example represented by the solid line.

As illustrated in FIG. 4, when the rotation speed of the tool 27 is too high, the temperature of the tool 27 is excessively increased due to the frictional heat. In this case, the heat input amount into the first member 31 and the second member 33 is excessive, and a burr is generated at the joint. Insufficiency of the heat input amount can cause a defect such as a cavity formed inside. As for the friction stir welding, the heat input amount mainly depends on the rotation speed of the tool 27 and the relative movement speeds of the members to be joined and the tool 27. According to the present embodiment, the heat input amount is properly set, and consequently, the joining speed of the friction stir welding is increased.

### 3. Friction Stir Welding Method

The friction stir welding method according to the present embodiment will now be described.

According to the present embodiment, the friction stir welding method includes a step of acquiring the proper condition of the proper rotation speed of the tool 27 to the relative movement speeds of the first member 31 and the second member 33, and the tool 27 and a step of performing the friction stir welding in a condition that satisfies the proper condition in a speed range in which the relative movement speeds exceed 3 m/min.

### Calculation of Proper Condition

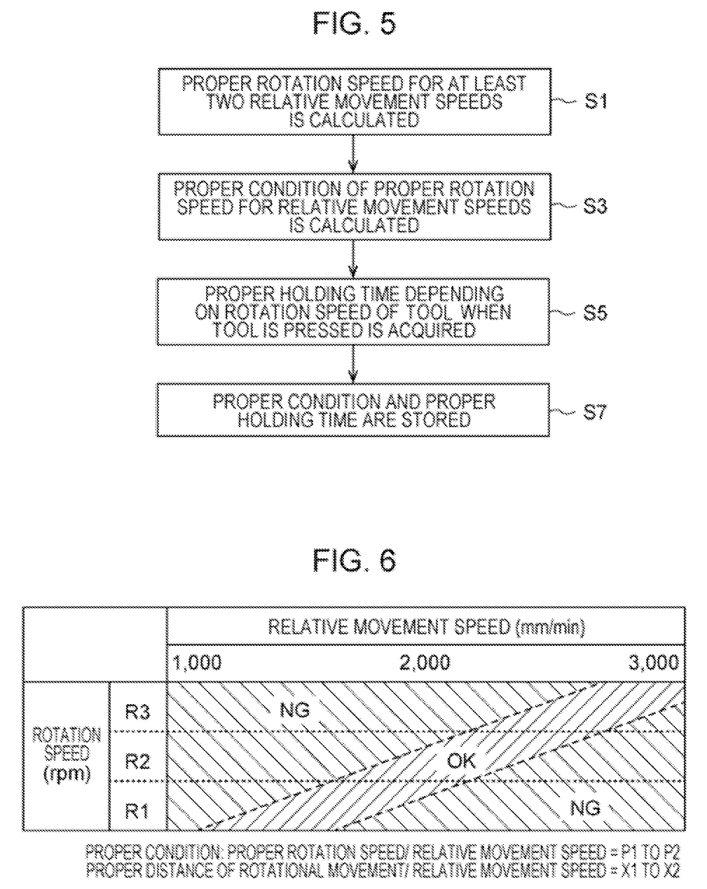

FIG. 5 is a flowchart illustrating a procedure for acquiring the proper condition.

A user first acquires the proper rotation speed of the tool 27 for at least two relative movement speeds (a step S1). At this time, the at least two relative movement speeds may be in a speed range that exceeds 3 m/min, or at least one of these may be equal to or less than 3 m/min. Alternatively, the at least two relative movement speeds may be in a speed range equal to or less than 3 m/min. In a small number of existing examples, the friction stir welding in the speed range in which the relative movement speeds exceed 3 m/min is practical. The speed range equal to or less than 3 m/min facilitates the calculation of the proper rotation speed of the tool 27 at which joining is proper.

The number of the relative movement speeds for acquiring the proper rotation speed of the tool 27 may be at least two but may be three or more. As the number of the relative movement speeds for acquiring the proper rotation speed of the tool 27 increases, the proper condition can be acquired with more precision. When the number of the relative movement speeds for acquiring the proper rotation speed of the tool 27 is too large, the number of processes for acquiring the proper condition increases. Accordingly, the number of the relative movement speeds for acquiring the proper rotation speed of the tool 27 may be two or three.

The proper rotation speed of the tool 27 for the relative movement speeds of the first member 31 and the second member 33, and the tool 27 may be acquired, for example, in a manner in which the friction stir welding is performed by using an actual apparatus, and the state of joining is evaluated.

Subsequently, the user acquires the proper condition of the proper rotation speed for the relative movement speeds, based on the proper rotation speed of the tool 27 for the at least two relative movement speeds that is acquired at the step S1 (a step S3). In the proper condition, the heat input amount of the first member 31 and the second member 33 per unit volume due to the frictional heat between the first member 31 and the tool 27 and between the second member 33 and the tool 27 can be proper. The higher the relative movement speeds, the higher the proper rotation speed. According to the present embodiment, the proper range of a ratio between each relative movement speed and the proper rotation speed is acquired as the proper condition. The proper condition may be the proper range of a ratio of the proper rotation speed to each relative movement speed or may be the proper range of a ratio of each relative movement speed to the proper rotation speed. The proper rotation speed of the tool 27 may be replaced with the distance of rotational movement of the tool 27 around the outer circumference of the joining pin 29. The proper condition can be expressed as an equation for the heat input amount into the tool 27 due to the frictional heat. The equation is expressed as a function of the rotation speed and the movement speed of the tool 27 and may be automatically calculated by a computer or may be calculated by the user.

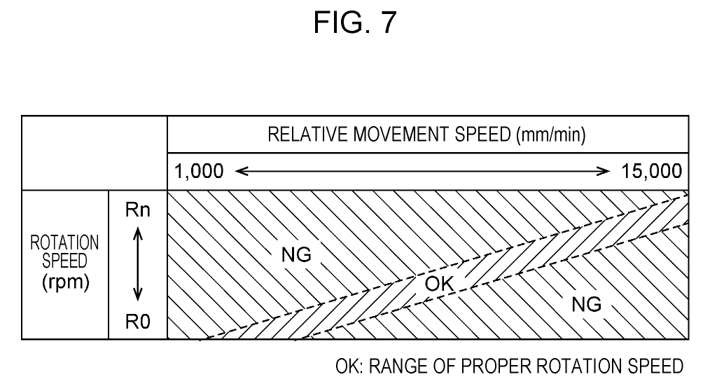

FIG. 6 and FIG. 7 illustrate examples of the proper range of the proper rotation speed for the relative movement speed.

FIG. 6 illustrates the result of evaluation of the state of joining when the relative movement speeds are in a range of 1,000 mm/min to 3,000 mm/min, and the rotation speed of the tool 27 is set at three stages of R1, R2, and R3 regarding relationships between the relative movement speeds and the proper rotation speed during the friction stir welding of the first member 31 and the second member 33.

In the example illustrated in FIG. 6, the ratio (the proper rotation speed/each relative movement speed) of the proper rotation speed to each relative movement speed at which the state of joining is good is from P1 to P2. When the proper rotation speed is replaced with the distance of rotational movement of the tool 27 around the outer circumference of the joining pin 29, the ratio (the proper distance of rotational movement/each relative movement speed) of the proper distance of rotational movement to each relative movement speed at which the state of joining is good is from X1 to X2.

When the ratio of the proper rotation speed to each relative movement speed is less than P1 (when the ratio of the proper distance of rotational movement to each relative movement speed is less than X1), the movement speed of the tool 27 is too high relative to the rotation of the tool 27, and a cavity is generated in the joint. When the ratio of the proper rotation speed to each relative movement speed exceeds P2 (when the ratio of the proper distance of rotational movement to each relative movement speed exceeds X2), the heat input amount due to the frictional heat is excessive, and an excess burr is generated. Accordingly, it is understood that even when the relative movement speeds change, the rotation speed of the tool 27 is adjusted to a rotation speed that satisfies the proper condition, the heat input amount is consequently set properly, and the state of joining becomes good.

FIG. 7 illustrates an example in which the speed range of the relative movement speeds is widened up to a high-speed range, and the proper condition is set by calculation, based on the result of calculation of the proper range illustrated in FIG. 6.

In the example illustrated in FIG. 7, when the relative movement speeds are in a range of 1,000 to 15,000 mm/min, the range of the rotation speed in which the ratio of the proper rotation speed for to relative movement speed is from P1 to P2 (the ratio of the proper distance of rotational movement to each relative movement speed is from X1 to X2) is set as the proper rotation speed (OK).

Subsequently, the user acquires a proper holding time depending on the rotation speed of the tool 27 when the tool 27 is pressed against the first member 31 and the second member 33 at the start of joining (a step S5). The holding time is a time until the tool 27 starts to relatively move after the joining pin 29 is inserted into the joint 35 to be made between the first member 31 and the second member 33 while the tool 27 is rotated at the start of joining. When the holding time is too short, a defect such as a cavity formed inside can be caused at the position of the start of joining. When the holding time is too long, there is a possibility that an excess burr is generated at the position of the start of joining, and the total time of joining increases. Accordingly, a factor for proper joining can be to set the holding time of the tool 27 properly at the start of joining.

For example, when the step S1 described above is performed, the user may also change the holding time of the tool 27 and acquire the proper holding time. In general, as the rotation speed of the tool 27 is small, the holding time is to secured, and as the rotation speed of the tool 27 decreases, the holding time is to be increased. When the rotation speed of the tool 27 is high, the holding time may be omitted (the proper holding time is 0 seconds). For example, in the examples in FIG. 6 and FIG. 7 described above, the proper holding time is 1 second when the rotation speed of the tool 27 is R1 mm/min, and the proper holding time is 0 seconds when the rotation speed of the tool 27 is equal to or more than R2 mm/min.

Subsequently, the user stores information about the proper condition that is acquired at the step S3 and the proper holding time that is acquired at the step S5 in the storage 53 of the control device 50 of the friction stir welding apparatus 1 (a step S7).

### Friction Stir Welding

The controller 51 of the control device 50 of the friction stir welding apparatus 1 controls the drive of the friction stir welding apparatus 1 by using the information about the proper condition and the proper holding time that are stored in the storage 53 and causes the first member 31 and the second member 33 to be joined by the friction stir welding in a speed range in which the relative movement speeds exceed 3 m/min. The information about the proper condition and the proper holding time is acquired depending on the first member 31 and the second member 33 to be joined and is stored in advance in the storage 53.

When the relative movement speeds of the first member 31 and the second member 33, and the tool 27 are constant during the friction stir welding, the rotation speed of the tool 27 is set at the proper rotation speed that satisfies the proper condition, and the holding time of the tool 27 at the start of joining is set at the proper holding time. As illustrated in FIG. 2 and FIG. 3 by way of example, the tool 27 is relatively moved along the joint 35 to be made, and the first member 31 and the second member 33 are joined to each other by the friction stir welding.

When an aspect in which the first member 31 and the second member 33 butt against each other or overlap at the joint 35 to be made between the first member 31 and the second member 33 changes, or depending on whether the joint 35 to be made between the first member 31 and the second member 33 has a linear shape or a curved shape, the relative movement speeds of the first member 31 and the second member 33, and the tool 27 are changed in some cases. According to the present embodiment, the proper condition of the proper rotation speed of the tool 27 in a wide speed range in which the relative movement speeds range from a low speed to a high speed is acquired and stored in the storage 53. Accordingly, during the friction stir welding, the controller 51 enables the relative movement speed of the tool 27 to be changed and enables the rotation speed of the tool 27 to be set at the proper rotation speed that satisfies the proper condition.

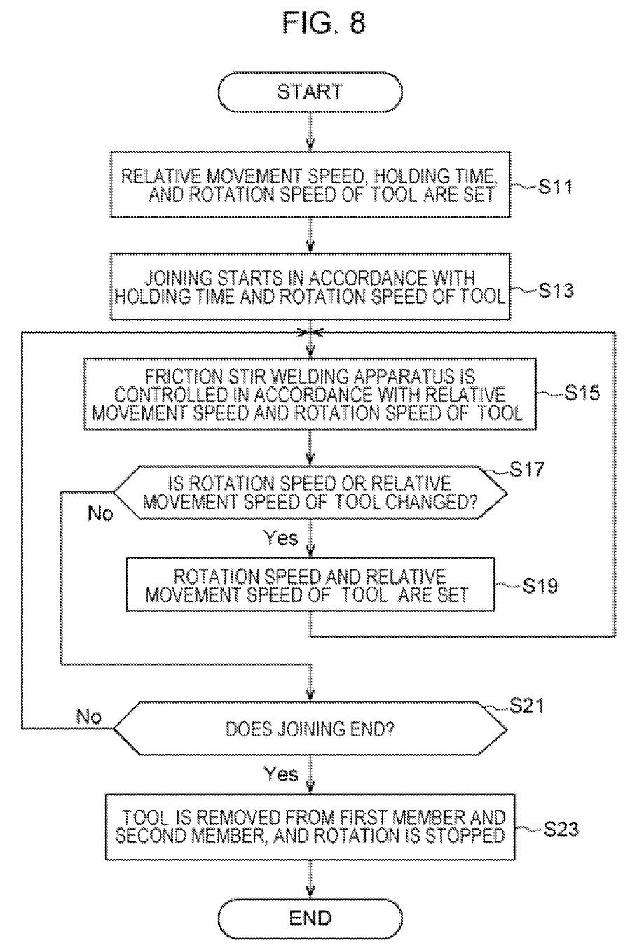

FIG. 8 illustrates an example of the processing of the controller 51 when the relative movement speed of the tool 27 is changed.

The controller 51 first reads information about control conditions and sets the relative movement speed, the holding time, and the rotation speed of the tool 27 at the start of joining (a step S11).

Subsequently, the controller 51 causes the friction stir welding apparatus 1 to be driven and starts joining in accordance with the holding time and the rotation speed of the tool 27 that are set (a step S13). For example, the controller 51 causes the joining pin 29 of the tool 27 to be inserted into the joint 35 to be made between the first member 31 and the second member 33 at the start position while the tool 27 is rotated at the set rotation speed and causes the shoulder member 28 of the tool 27 to be pressed against the joint 35 to be made. When the set holding time has been elapsed after the tool 27 is inserted, the controller 51 causes the tool 27 to start relatively moving.

Subsequently, the controller 51 controls the drive of the friction stir welding apparatus 1 in accordance with the relative movement speed and the rotation speed of the tool 27 that are set (a step S15). Consequently, the tool 27 moves along the joint 35 to be made between the first member 31 and the second member 33 while rotating at the proper rotation speed, and joining the first member 31 and the second member 33 to each other progresses.

Subsequently, the controller 51 determines whether the rotation speed or the relative movement speed of the tool 27 is changed (a step S17). For example, when a line (a joint line to be made) of the joint 35 to be made is bent or curved, the relative movement speed is to be decreased, for example, for the reason of the operability of a mechanism for relatively changing the position of the tool 27. For example, the controller 51 acquires information about the start position and the end position of the joint 35 to be made between the first member 31 and the second member 33 and information about the shape of the joint line to be made of the joint 35 to be made and the relative movement speed at sections of the joint line to be made in advance before joining. The controller 51 refers to the information and determines whether the relative movement speed is changed.

The information that is acquired in advance may not be information about the relative movement speed at the sections of the joint line to be made but may be information about the rotation speed of the tool 27 at the sections of the joint line to be made.

When it is determined that the rotation speed or the relative movement speed of the tool 27 is changed (Yes at the step S17), the controller 51 refers to the information about the proper condition and sets the rotation speed and the relative movement speed of the tool 27 such that the proper condition is satisfied (a step S19). Subsequently, the controller 51 performs the step S15 again. When it is not determined that the rotation speed or the relative movement speed of the tool 27 is changed (No at the step S17), the controller 51 determines whether joining ends (a step S21). For example, when the tool 27 reaches a predetermined end position, the controller 51 determines that joining ends.

When it is not determined that joining ends (No at the S21), the controller 51 performs the step S15 again. When it is determined that joining ends (Yes at the step S21), the controller 51 causes the tool 27 to ascend, causes the tool 27 to be removed from the first member 31 and the second member 33, and causes the tool 27 to stop rotating (a step S23).

### 4. Effects

The friction stir welding method according to the present embodiment includes acquiring the proper rotation speed of the tool 27 for at least two relative movement speeds, acquiring the proper condition of the proper rotation speed for the at least two relative movement speeds, based on the proper rotation speed for the at least two relative movement speeds, and performing the friction stir welding of the first member 31 and the second member 33 in a condition that satisfies the proper condition in a speed range in which the relative movement speeds exceed 3 m/min as described above. Accordingly, the proper condition that is generalized in a wide speed range is acquired from the proper rotation speed of the tool 27 for the at least two relative movement speeds depending on the first member 31 and the second member 33 to be joined, and the joining speed can be increased. Accordingly, the heat input amount can be properly set, the joining speed can be increased, and the productivity can be improved.

In addition, in the friction stir welding method according to the present embodiment, the proper range of the ratio between the proper rotation speed and the relative movement speed of the tool 27 is acquired as the proper condition. Consequently, the proper rotation speed of the tool 27 when the relative movement speed of the tool 27 is increased in a wide range can be readily set.

In addition, in the friction stir welding method according to the present embodiment, the at least two relative movement speeds for acquiring the proper rotation speed of the tool 27 may be equal to or less than 3 m/min. As for existing friction stir welding that is put into practical use, the relative movement speed of the tool 27 is equal to or less than 3 m/min. For this reason, the generalized proper condition can be accurately acquired from the proper rotation speed for the relative movement speeds in the speed range.

In addition, in the friction stir welding method according to the present embodiment, during the friction stir welding, the rotation speed or the relative movement speed of the tool 27 may be changed, and the relative movement speed and the rotation speed of the tool 27 may be set such that the proper condition is satisfied. This enables the heat input amount to be properly set at the sections even when joining conditions change for every section of the joint 35 to be made between the first member 31 and the second member 33, and the productivity can be improved while the state of joining is kept proper.

In addition, the friction stir welding method according to the present embodiment may further include acquiring the proper holding time depending on the rotation speed of the tool 27 when the tool 27 is inserted into the joint 35 to be made while the tool 27 is rotated. This enables a defect such as a burr or a cavity to be prevented from being caused at the position of the start of joining.

In addition, the friction stir welding apparatus 1 according to the present embodiment includes the storage 53 that stores the proper condition of the proper rotation speed for the relative movement speeds, and the proper condition is acquired based on the proper rotation speed for the at least two relative movement speeds. The controller 51 sets the rotation speed and the relative movement speed of the tool 27 in a condition that satisfies the proper condition in a speed range in which the relative movement speeds exceed 3 m/min and controls the actuation of the friction stir welding apparatus 1. This enables the friction stir welding apparatus 1 to be driven depending on the proper condition that is generalized in a wide speed range and enables the joining speed to be increased. Accordingly, the heat input amount can be properly set, the joining speed can be increased, and the productivity can be improved.

The embodiment of the disclosure is described above in detail with reference to the attached drawings. The disclosure, however, is not limited to the embodiment. It is clear for a person skilled in the art to conceive various modifications and alterations within the range of technical ideas recited in claims, and these are naturally included in the technical range of the disclosure. For example, functions that are included in the components or the steps, for example, can be rearranged without logical contradiction, and multiple components or steps, for example, can be combined or split.

For example, during the friction stir welding, the controller 51 may keep the relative movement speed of the tool 27 constant and may change the rotation speed of the tool 27 into the proper rotation speed that satisfies the proper condition. For example, when the joining strength partly changes, or the shapes or compositions of the first member 31 and the second member 33, for example, partly change, the proper condition for these conditions may be stored in advance in the storage 53, and the rotation speed of the tool 27 may be changed while the relative movement speed kept constant. This enables the friction stir welding to be continuously performed and enables the productivity to be improved even when the joining strength changes, or the shapes or compositions of the first member 31 and the second member 33, for example, change.

The technique of the disclosure can be provided as a computer program that causes a computer to function as the control device 50 described above and a non-transitory physical recording medium in which the computer program is recorded.

The control device 50 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 50 including the storage 53 and the controller 51. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A friction stir welding method in which a tool is inserted into a joint to be made between a first member and a second member while the tool is rotated, and the first member and the second member, and the tool are relatively moved along the joint to be made such that the first member and the second member are softened, to perform friction stir welding of the first member and the second member, the friction stir welding method comprising:
acquiring a proper rotation speed of the tool for each of at least two relative movement speeds;
acquiring a proper condition of the proper rotation speed for each of the at least two relative movement speeds, based on the proper rotation speed for each of the at least two relative movement speeds; and
performing the friction stir welding of the first member and the second member in a speed range in which a relative movement speed of the first member and a relative movement speed of the second member exceed 3 m/min in a condition that satisfies the proper condition.

2. The friction stir welding method according to claim 1,
wherein a proper range of a ratio between the proper rotation speed and a relative movement speed of the tool is acquired as the proper condition.

3. The friction stir welding method according to claim 1,
wherein the at least two relative movement speeds are equal to or less than 3 m/min.

4. The friction stir welding method according to claim 1,
wherein during the friction stir welding, a relative movement speed of the tool is changed, and a rotation speed of the tool is set at the proper rotation speed that satisfies the proper condition.

5. The friction stir welding method according to claim 1,
wherein during the friction stir welding, a rotation speed of the tool is changed, and a relative movement speed of the tool is set at a relative movement speed that satisfies the proper condition.

6. The friction stir welding method according to claim 1,
wherein during the friction stir welding, a relative movement speed of the tool is constant, and a rotation speed of the tool is changed into the proper rotation speed that satisfies the proper condition.

7. The friction stir welding method according to claim 1, further comprising
acquiring a proper holding time depending on a rotation speed of the tool at which the tool is inserted into the joint to be made while the tool is rotated.

8. A friction stir welding apparatus configured to insert a tool into a joint to be made between a first member and a second member while the tool is rotated, and relatively move the first member and the second member, and the tool along the joint to be made such that the first member and the second member are softened, to perform friction stir welding of the first member and the second member, the friction stir welding apparatus comprising:
a storage configured to store a proper condition of a proper rotation speed for each of at least two relative movement speeds, the proper condition being acquired based on the proper rotation speed for each of the at least two relative movement speeds; and
a controller configured to
set a rotation speed and a relative movement speed of the tool in a speed range in which a relative movement speed of the first member and a relative movement speed of the second member exceed 3 m/min in a condition that satisfies the proper condition; and
control actuation of the friction stir welding apparatus.

9. A friction stir welding apparatus configured to insert a tool into a joint to be made between a first member and a second member while the tool is rotated, and relatively move the first member and the second member, and the tool along the joint to be made such that the first member and the second member are softened, to perform friction stir welding of the first member and the second member, the friction stir welding apparatus comprising
circuitry configured to
store a proper condition of a proper rotation speed for each of at least two relative movement speeds, the proper condition being acquired based on the proper rotation speed for each of the at least two relative movement speeds;
set a rotation speed and a relative movement speed of the tool in a speed range in which a relative movement speed of the first member and a relative movement speed of the second member exceed 3 m/min in a condition that satisfies the proper condition; and
control actuation of the friction stir welding apparatus.
